(19) United States
(12) Patent Application Publication
(10) Pub. No.: US 2015/0011212 A1
(43) Pub. Date: Jan. 8, 2015

(54) MANAGING BANDWIDTH AND CONNECTION COSTS FOR MOBILE DEVICES

(71) Applicant: Valentin Andrei, Bucharest (RO)

(72) Inventor: Valentin Andrei, Bucharest (RO)

(21) Appl. No.: 14/126,294

(22) PCT Filed: May 16, 2013
(86) PCT No.: PCT/IB2013/001392

§ 371 Date: Dec. 13, 2013

(51) Int. Cl. H04W 36/16; H04W 4/02

(52) U.S. Cl. CPC H04W 36/165; H04W 4/02; H04W 36/32
USPC 455/436

(57) ABSTRACT

One particular example implementation of an apparatus includes logic, the logic at least partially comprising hardware logic to: determine a location of a mobile device along a route from a first location to a second location, where a plurality of wireless networks are available along the route and automatically switch from a first connection between the mobile device and a first wireless network to a second connection between the mobile device and a second wireless network.

### TECHNICAL FIELD

Embodiments described herein generally relate to managing bandwidth and connection costs for mobile devices.

### BACKGROUND

Networking architectures have grown increasingly complex in communications environments, particularly mobile wireless environments. Wireless communication technologies are used in connection with many applications, including satellite communications systems, portable digital assistants (PDAs), laptop computers, mobile devices (e.g., cellular telephones, user equipment), etc. Wireless communication technologies are handling increasing amounts of data traffic volume, and the types of data being transported through mobile wireless networks have changed dramatically. This is in part because mobile devices are becoming more sophisticated and, further, are able to engage in more data-intensive activities such as displaying movies or playing video games. Video, file-sharing, and other types of usages (more traditionally associated with wired networks) have been gradually displacing voice as the dominant traffic in mobile wireless networks. When traveling along a route, often there can be several different wireless networks that are available. However, while on the route, there can be a significant challenge in determining a wireless network to use that provides good quality of service and/or is not cost prohibitive.

### BRIEF DESCRIPTION OF THE DRAWINGS

Embodiments are illustrated by way of example and not limitation in the figures of the accompanying drawings, in which like references indicate similar elements and in which:

FIG. 1 is a simplified block diagram illustrating an embodiment of communication network, in accordance with at least one embodiment of the present disclosure;

FIG. 2 illustrates, for at least one embodiment, a simplified block diagram associated with a communication network in accordance with at least one embodiment of the present disclosure;

FIG. 3 illustrates, for at least one embodiment, a simplified block diagram associated with a communication network in accordance with at least one embodiment of the present disclosure;

FIG. 4A illustrates, for at least one embodiment, a simplified block diagram associated with a network communication in accordance with at least one embodiment of the present disclosure;

FIG. 4B illustrates, for at least one embodiment, an example network table in accordance with at least one embodiment of the present disclosure;

FIG. 5 illustrates, for at least one embodiment, a simplified block diagram associated with a communication network in accordance with at least one embodiment of the present disclosure;

FIG. 6 illustrates, for at least one embodiment, an example flow diagram in accordance with at least one embodiment of the present disclosure;

FIG. 7 is a simplified block diagram associated with an example ARM ecosystem system on chip (SOC) of the present disclosure; and

FIG. 8 is a simplified block diagram illustrating example logic that may be used to execute activities associated with the present disclosure.

### DETAILED DESCRIPTION

The following detailed description sets forth embodiments of apparatuses, methods, and systems relating to dual touch surface multiple function input devices. Features, such as structure(s), function(s), and/or characteristic(s) for example, are described with reference to one embodiment as a matter of convenience; various embodiments may be implemented with any suitable one or more described features.

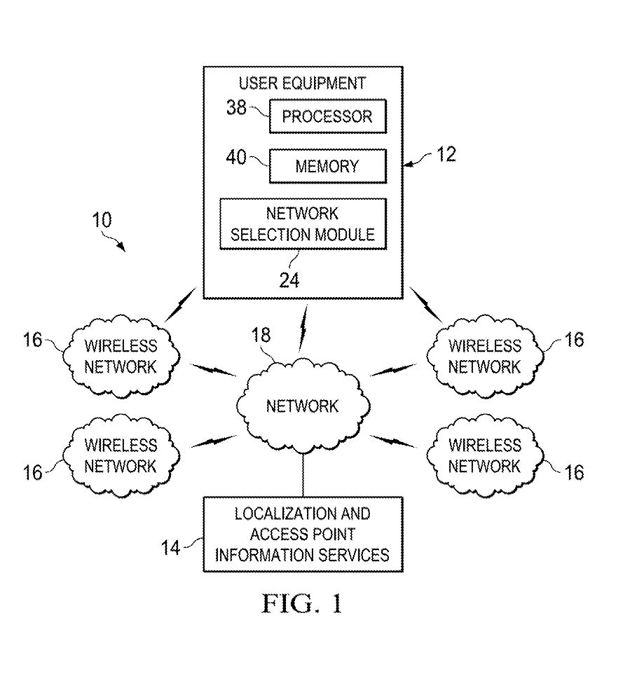

FIG. 1 is a simplified block diagram illustrating an embodiment of a communication system 10, in accordance with at least one embodiment. Communication system 10 can include user equipment 12, a localization and access point information services module 14, a plurality of wireless networks 16, and a network 18. User equipment can include a network selection module 24, a processor 38, and memory 40. One or more of the plurality of wireless networks 16 may overlap and may be able communicate with each other without going through network 18. Each wireless network in plurality of wireless networks 16 may be a wireless personal area network (WPAN), a wireless local area network (WLAN), a wireless mesh network, a wireless metropolitan area network (WMAN), a wireless wide area network (WWAN), or a cellular network such as a Global System for Mobile Communications (GSM), General Packet Radio Service (GPRS), cdmaOne, CDMA2000, Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/TDMA), Integrated Digital Enhanced Network (iDEN), Long Term Evolution (LTE), etc.

Network 18 represents a series of points or nodes of interconnected communication paths for receiving and transmitting packets of information that propagate through communication system 10. Network 18 can offer a communicative interface between user equipment 12 and one or more of the plurality of wireless networks 16, and may be any local area network (LAN), WLAN, metropolitan area network (MAN), wide area network (WAN), VPN, Intranet, Extranet, or any other appropriate architecture or system that facilitates communications in a network environment. Network 18 may be a wireless network similar to a wireless network in plurality of wireless networks 16. In one example, user equipment 12 may communicate directly with one or more of the plurality of networks 16 without using network 18. The examples of FIG. 1 are merely examples of a communication network, and do not limit the scope of the claims. For example, the number of networks (e.g., plurality of wireless networks 16) may vary, the location of the networks may vary, the type of the networks may vary and/or the like.

Processor 38 can execute any type of instructions associated with data to achieve the operations detailed herein in this Specification. In one example, processor 38 could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that can include digital logic, software, code, electronic instructions, or any suitable combination thereof.

Currently, mobile devices can connect to the Internet using 2G/3G/4G, WiFi, WiMax, LTE, etc. However the costs of maintaining a data connection when exceeding the traffic limit allocated by an operator can be high. User equipment 12 can be configured to switch to a free of charge access point if possible. Also user equipment 12 can be configured to keep desired quality of service (QoS) parameters for a connection automated such that user equipment 12 may switch from a wireless network user equipment 12 is currently connect to to a different wireless network with better QoS parameters. While there are existing networking standards that define a stack layer between L2 and L3 that can enable a unique communication protocol to the upper layers, no matter the access technology, the existing networking standards raise a problem of discovering access points on a projected trajectory of user equipment 12.

In an embodiment, user equipment 12 can be configured to automatically change from a currently connected wireless network to another wireless network based on a predefined route or set of policies (or both). User equipment 12 may also be configured to learn route patterns in order to improve overall connectivity cost. To provide a seamless vertical handover, user equipment 12 may be aware of the access points that can occur during movement along a route. In an embodiment, an automode may be enabled such that network selection module 24 may match a route or portions of a route to a known route and apply a rule set of the known route to connect with wireless networks along the route.

User equipment 12 includes any type of client device, endpoint, etc. that is capable of communicating in a network environment. In addition, the term ‘user equipment’ is used interchangeably with ‘mobile device’ herein. Moreover, user equipment 12 can be associated with any devices, customers, or end users wishing to receive data or content in the system via some network. The term ‘user equipment’ is inclusive of devices used to initiate a communication, such as any type of receiver, a computer, a set-top box, an Internet radio device (IRD), a cell phone, a smartphone, a laptop, a tablet, a personal digital assistant (PDA), a Google Android™, an iPhone™, an iPad™, a Microsoft Surface™, or any other device, component, element, endpoint, or object capable of initiating voice, audio, video, media, or data exchanges within communication system 10. User equipment 12 may also be inclusive of a suitable interface to the human user, such as a display, a keyboard, a touchpad, a remote control, or any other terminal equipment. User equipment 12 may also be any device that seeks to initiate a communication on behalf of another entity or element, such as a program, a database, or any other component, device, element, or object capable of initiating an exchange within communication system 10. Data, as used herein in this document, refers to any type of numeric, voice, video, media, audio, or script data, or any type of source or object code, or any other suitable information in any appropriate format that may be communicated from one point to another.

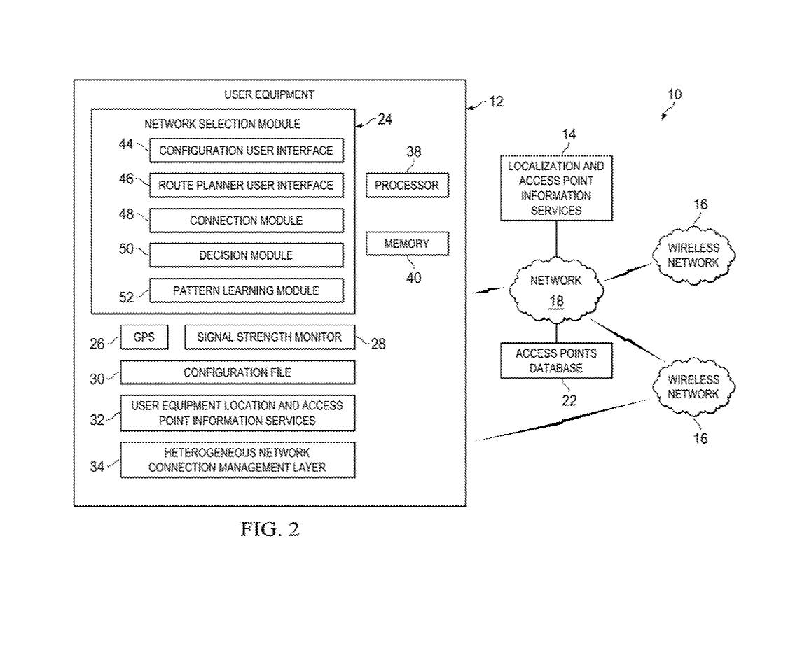

FIG. 2 is a simplified block diagram illustrating an embodiment of a communication system 10, in accordance with at least one embodiment. Communication system 10 can include user equipment 12, localization and access point information services module 14, plurality of wireless networks 16, network 18, and an access points database 22. User equipment 12 can include network selection module 24, a global positioning system (GPS) 26, a signal strength monitor 28, a configuration file 30, user equipment location and access point information service 32, a heterogeneous network connection management layer 34, processor 38, and memory 40. In one example, configuration file 30 may be included in memory 40. Network selection module 24 can include a configuration user interface (UI) 44, a route planner UI 46, a connection module 48, a decision module 50, and a pattern learning module 52.

Connection module 48 can initiate a succession of handover connections to one of plurality of wireless networks 16 by communicating with heterogeneous network connection management layer 34. In an example, when network selection module 24 is in an automated mode, inputs from decision module 50 may be used to initiate the succession of connections. In another example, as described below, configuration file 30 may be used when network selection module 24 is in a preconfigured mode. Configuration UI 44 can be configured to allow QoS or cost thresholds (or both) to be set and then used by decision module 50 to influence a succession of connections when user equipment 12 is in automode.

Route planner UI 46 can be configured to connect to localization and access point information services module 14 and display possible routes between 2 locations. Further, route planner UI 46 may offer the possibility of adding desired QoS or cost parameters (or both) that may be used when selecting wireless networks to be connected to on the route. After a user has defined parameters for connecting to a wireless network 16, route planner UI 46 can then compute a succession of connections to wireless networks along the route and store them in configuration file 30. In an example, route planner UI 46 may use decision module 50 and compute the succession of connections to wireless networks along the route while offline. Route planner UI 46 can be configured to inform the user of the succession of connections to each wireless network and to allow a user to change one or more selections to determine the final settings.

Connection module 48 can be configured to monitor what connections could be made, the requirements for the connections, and when the connections could be made. Pattern learning module 52 can be configured to learn some of the most frequent routes used and is capable of analyzing possible combinations of handover successions to allow for improved QoS and a reduction in cost of data connections. Signal strength monitor 28 can be configured such that when the signal strength from a wireless network falls below an established (or predetermined) threshold, a signal may be sent to heterogeneous network connection management layer 34 to initiate a switch (or handover) of wireless networks.

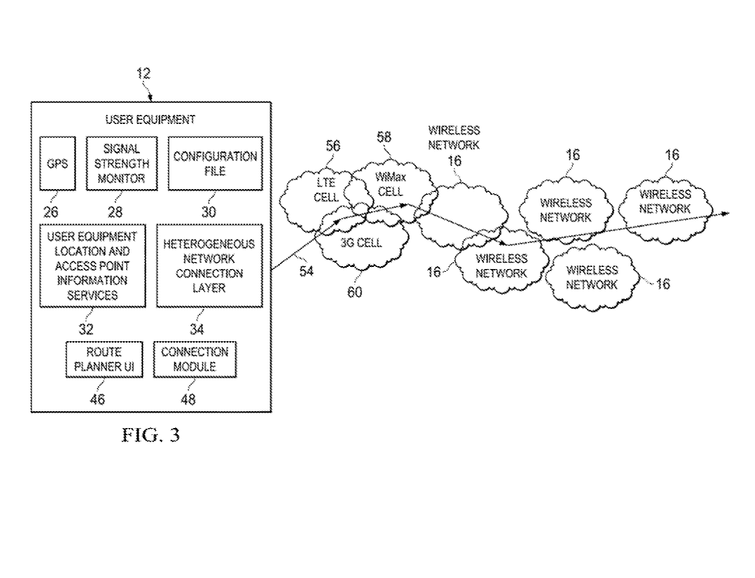

FIG. 3 is a simplified block diagram illustrating an embodiment of a route passing through several wireless networks, in accordance with at least one embodiment. In an embodiment, a route 54 is entered into user equipment 12 through route planner UI 46. The route may pass through a LTE cell 56, a WiMax cell 58, a 3G cell 60, and various other wireless networks 16. User equipment location and access point information services 32 can obtain a list of the wireless networks available on the route (e.g., LTE cell 56, WiMax cell 58, 3G cell 60, and various other wireless networks 16) with information or parameters regarding each wireless network from localization and access point information services module 14 (not shown). Using route planner UI 46, a user can generate a route and store the route in configuration file 30. Connection module 48 can read the generated route in configuration file 30 and prepare the connection handover actions for each wireless network to be sent to heterogeneous network connection management layer 34. As user equipment 12 starts moving along the route, user equipment location and access point information services 32 can use GPS 26 to obtain information about the wireless networks available on the route. Along the route, if signal strength monitor 28 detects the signal strength starting to fall for a current connection to a wireless network or a more preferable wireless network is available, heterogeneous network connection management layer 34 can initiate a switching action based on configuration file 30 and user equipment location and access point information services 32.

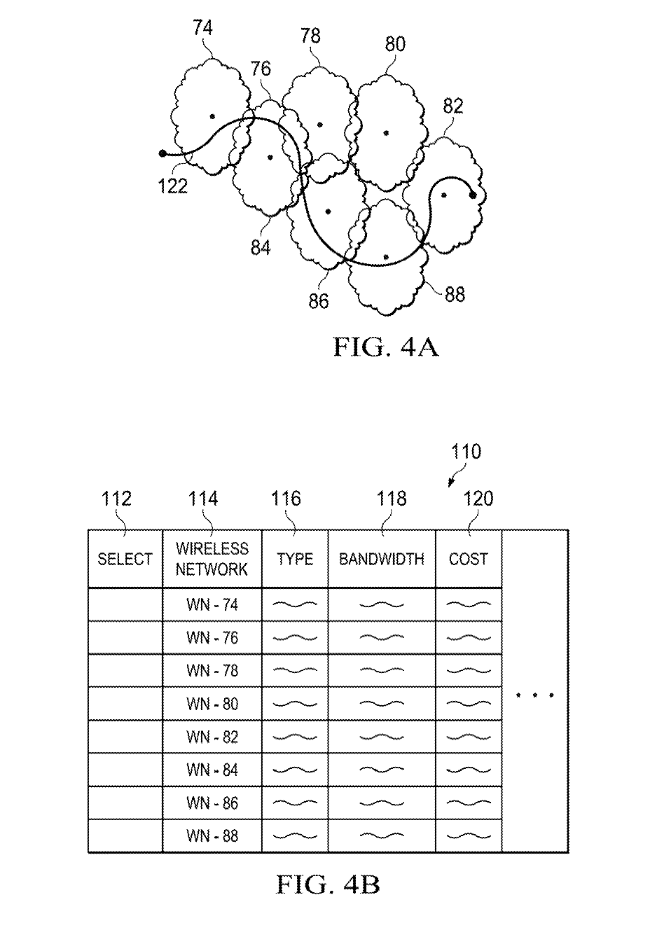

FIG. 4A is a simplified diagram illustrating an embodiment of a route passing through several wireless networks, in accordance with at least one embodiment. Route 122 passes through wireless networks 74-88. In some places along route 120, some of the wireless networks overlap (e.g., wireless network 74 overlaps with wireless network 76). In other cases, only one wireless network is available along route 120 (e.g., at the start of route 120, only wireless network 74 is available). Where the wireless networks overlap, a choice can be made to connect to a more preferred wireless network. A table similar to the table illustrated in FIG. 4B below, (or some other means) may be used in the selection of a more preferred wireless network.

FIG. 4B is a simplified table 110 illustrating an embodiment of information regarding the available wireless networks along route 122 shown in FIG. 4A, in accordance with at least one embodiment. Table 110 can include a select wireless network column 112, a wireless network name column 114 (possibly including carrier information), a type of network column 116, a bandwidth column 118 that shows the bandwidth of the wireless network, and a cost column 120 that shows the cost of using the wireless network. Other columns may also be used to display other types of information about each wireless network available along the route. Based on the information in table 110, select wireless network column 112 can be used to select preferred wireless networks that are to be used along the route.

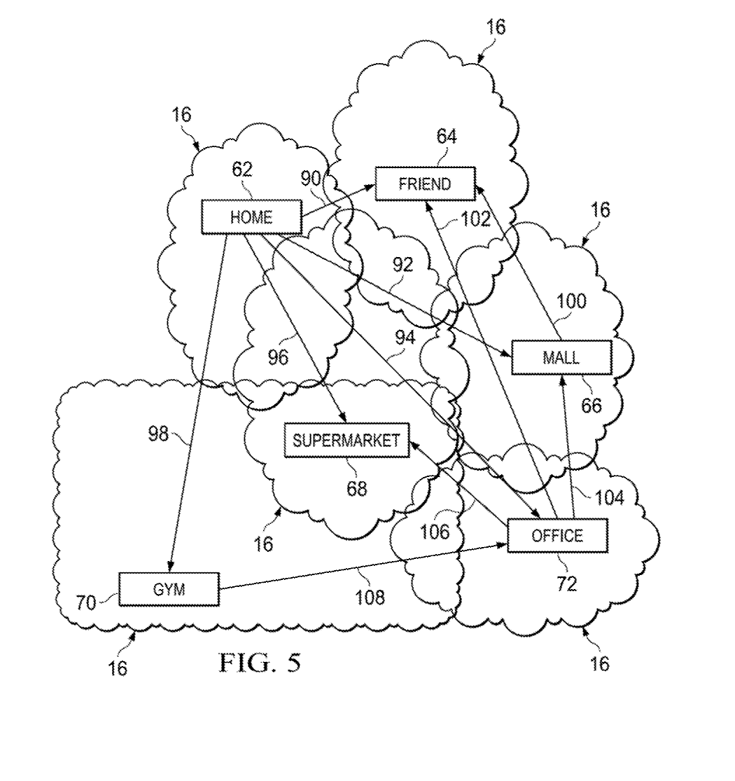

FIG. 5 is a simplified diagram illustrating an embodiment of different commonly used routes that may pass through several wireless networks, in accordance with at least one embodiment. For example, a home to friend route 90 may be a route from a home 62 to a friend 64, a home to mall route 92 may be a route from home 62 to a mall 66, a home to office route 94 may be from home 62 to an office 72, a home to supermarket route 96 may be from home 62 to a supermarket 68, a home to gym route 98 may be from home 62 to a gym 70, a mall to friend route 100 may be a route from mall 66 to friend 64, an office to friend route 102 may be a route from office 72 to friend 64, an office to mall route 104 may be a route from office 72 to mall 66, an office to supermarket route 106 may be a route from office 72 to supermarket 68, and a gym to office route 108 may be a route from gym 70 to office 72. Based on the location of user equipment 12, pattern learning module 52 can be configured to construct a map of routes. For each position or location of user equipment 12 on a particular route, decision module 50 can compute costs and QoS parameters of wireless networks 16 along a particular route by using information from user equipment location and access point information services 32, for alternate connections. If there is a wireless network from a QoS or costs point of view (or both) that is more preferable than a currently connected wireless network, the next time user equipment 12 travels across the same trajectory, the new succession of wireless networks may be applied.

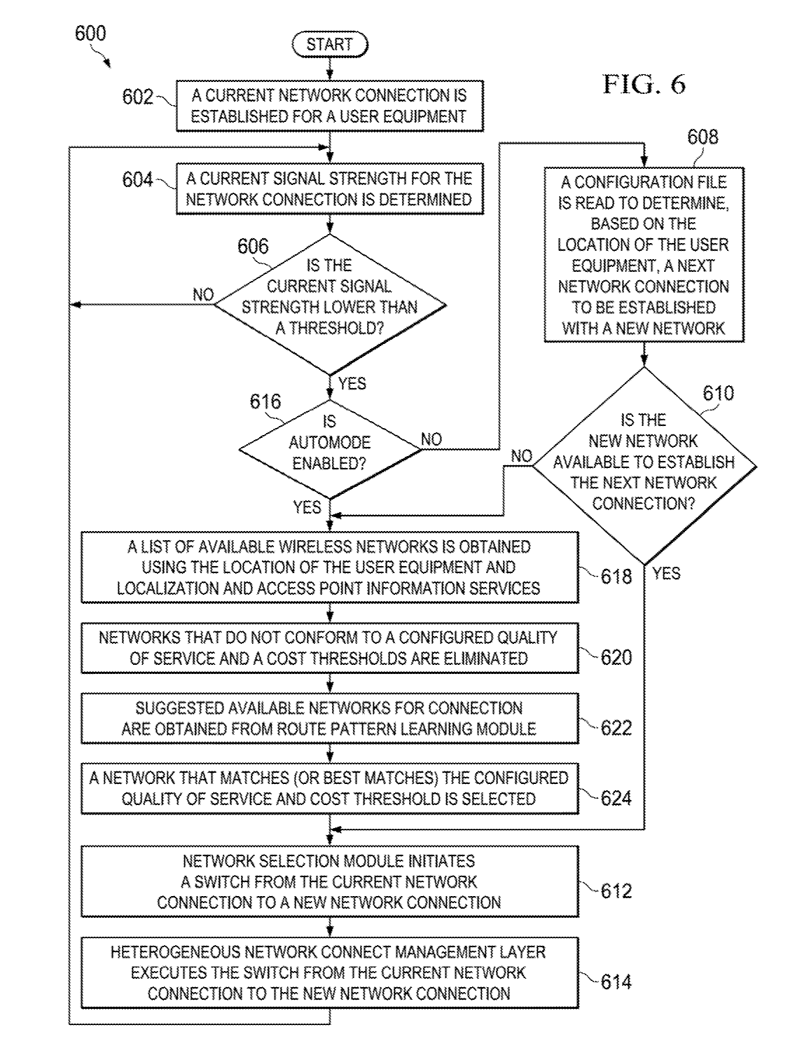

FIG. 6 is a simplified flowchart 600 illustrating example activities of managing bandwidth and connection costs for mobile devices in accordance with at least one embodiment of the present disclosure. At block 602, a current network connection is established for a user equipment. At block 604, a current signal strength for the network connection is determined. At block 606, the system determines if the current signal strength is lower than a threshold. The threshold may be set by a user or may be automatically set by user equipment 12. The threshold may be a percentage of a full or strong signal or may be a static numeric value of signal power or signal strength. If the current signal strength is not lower than a threshold, then a current signal strength for the network connection is (again) determined, as in 604. If the current signal strength is lower than a threshold, then the system determines if automode is enabled, as in 616.

If automode is not enabled, then a configuration file is read to determine, based on the location of the user equipment, a next network connection to be established with a new network, as in 608. At block 610, the system determines if the new network is available to establish the next network connection. If a new network is available to establish the next network connection, then network selection module initiates a handover from the current network connection to the new network connection, as in 612. At block 614, a heterogeneous network connection management layer executes the switch (or handover) from the current network connection to the new network connection.

Going back to 604, if the current signal strength is lower than a threshold, then the system determines if automode is enabled, as in 616. If automode is enabled, then a list of available wireless networks is obtained using the location of the user equipment and localization and access point information services (e.g., using localization and access point information services module 14), as in 618. Going back to block 610, if a new network is not available to establish the next network connection, then a list of available wireless networks is obtained using the location of the user equipment and localization and access point information services, as in 618.

At block 620, networks that do not conform to a configured quality of service and a cost threshold are eliminated. At block 622, suggested available networks for connection are obtained from route pattern learning module. At block 624, a network that matches (or best matches) the configured quality of service and cost threshold is selected. At 612, network selection module initiates a switch from the current network connection to the new network connection.

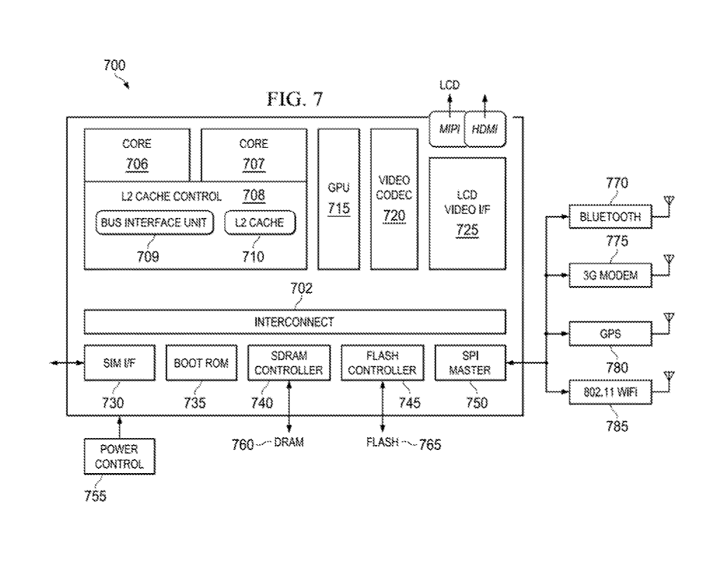

FIG. 7 is a simplified block diagram associated with an example ARM ecosystem SOC 700 of the present disclosure. At least one implementation of the present disclosure can include an integration of the managing connection cost and bandwidth features discussed herein and an ARM component. For example, the example of FIG. 7 can be associated with any ARM core (e.g., A-9, A-15, etc.). Further, the architecture can be part of any type of tablet, smartphone (inclusive of Android™ phones, I-Phones™), I-Pad™, Google Nexus™, Microsoft Surface™, personal computer, server, video processing components, laptop computer (inclusive of any type of notebook), Ultrabook™ system, any type of touch-enabled input device, etc.

In this example of FIG. 7, ARM ecosystem SOC 700 may include multiple cores 706-707, an L2 cache control 708, a bus interface unit 709, an L2 cache 710, a graphics processing unit (GPU) 715, an interconnect 702, a video codec 720, and a liquid crystal display (LCD) I/F 725, which may be associated with mobile industry processor interface (MIPI)/high-definition multimedia interface (HDMI) links that couple to an LDC.

ARM ecosystem SOC 700 may also include a subscriber identity module (SIM) I/F 730, a boot read-only memory (ROM) 735, a synchronous dynamic random access memory (SDRAM) controller 740, a flash controller 745, a serial peripheral interface (SPI) master 750, a suitable power control 755, a dynamic RAM (DRAM) 760, and flash 765. In addition, one or more example embodiment include one or more communication capabilities, interfaces, and features such as instances of Bluetooth™ 770, a 3G modem 775, a global positioning system (GPS) 780, and an 802.11 WiFi 785.

In operation, the example of FIG. 7 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

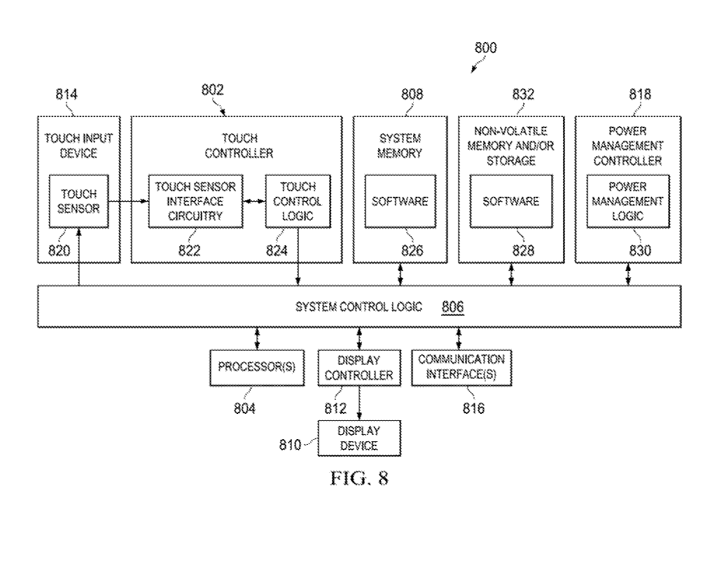

FIG. 8 is a simplified block diagram illustrating potential electronics and logic that may be associated with any of the managing connection costs and bandwidth operations discussed herein. In at least one example embodiment, system 800 can include a touch controller 802, one or more processors 804, system control logic 806 coupled to at least one of processor(s) 804, system memory 808 coupled to system control logic 806, non-volatile memory and/or storage device(s) 832 coupled to system control logic 806, display controller 812 coupled to system control logic 832, display controller 812 coupled to a display device 810, power management controller 818 coupled to system control logic 806, and/or communication interfaces 816 coupled to system control logic 806.

System control logic 806, in at least one embodiment, can include any suitable interface controllers to provide for any suitable interface to at least one processor 804 and/or to any suitable device or component in communication with system control logic 806. System control logic 806, in at least one example embodiment, can include one or more memory controllers to provide an interface to system memory 808. System memory 808 may be used to load and store data and/or instructions, for example, for system 800. System memory 808, in at least one example embodiment, can include any suitable volatile memory, such as suitable dynamic random access memory (DRAM) for example. System control logic 806, in at least one example embodiment, can include one or more I/O controllers to provide an interface to display device 810, touch controller 802, and non-volatile memory and/or storage device(s) 832.

Non-volatile memory and/or storage device(s) 832 may be used to store data and/or instructions, for example within software 828. Non-volatile memory and/or storage device(s) 832 may include any suitable non-volatile memory, such as flash memory for example, and/or may include any suitable non-volatile storage device(s), such as one or more hard disc drives (HDDs), one or more compact disc (CD) drives, and/or one or more digital versatile disc (DVD) drives for example.

Power management controller 818 may include power management logic 830 configured to control various power management and/or power saving functions or any part thereof. In at least one example embodiment, power management controller 818 is configured to reduce the power consumption of components or devices of system 800 that may either be operated at reduced power or turned off when the electronic device is in a low power configuration. For example, in at least one example embodiment, when the electronic device is in a low power configuration, power management controller 818 performs one or more of the following: power down the unused portion of the display and/or any backlight associated therewith; allow one or more of processor(s) 804 to go to a lower power state if less computing power is required in the closed configuration; and shutdown any devices and/or components that are unused when an electronic device is in the closed configuration.

Communications interface(s) 816 may provide an interface for system 800 to communicate over one or more networks and/or with any other suitable device. Communications interface(s) 816 may include any suitable hardware and/or firmware. Communications interface(s) 816, in at least one example embodiment, may include, for example, a network adapter, a wireless network adapter, a telephone modem, and/or a wireless modem.

System control logic 806, in at least one example embodiment, can include one or more I/O controllers to provide an interface to any suitable input/output device(s) such as, for example, an audio device to help convert sound into corresponding digital signals and/or to help convert digital signals into corresponding sound, a camera, a camcorder, a printer, and/or a scanner.

For at least one example embodiment, at least one processor 804 may be packaged together with logic for one or more controllers of system control logic 806. In at least one example embodiment, at least one processor 804 may be packaged together with logic for one or more controllers of system control logic 806 to form a System in Package (SiP). In at least one example embodiment, at least one processor 804 may be integrated on the same die with logic for one or more controllers of system control logic 806. For at least one example embodiment, at least one processor 804 may be integrated on the same die with logic for one or more controllers of system control logic 806 to form a System on Chip (SoC).

For touch control, touch controller 802 may include touch sensor interface circuitry 822 and touch control logic 824. Touch sensor interface circuitry 822 may be coupled to detect touch input over a first touch surface layer and a second touch surface layer of a display (i.e., display device 810). Touch sensor interface circuitry 822 may include any suitable circuitry that may depend, for example, at least in part on the touch-sensitive technology used for a touch input device. Touch sensor interface circuitry 822, in one embodiment, may support any suitable multi-touch technology. Touch sensor interface circuitry 822, in at least one embodiment, can include any suitable circuitry to convert analog signals corresponding to a first touch surface layer and a second surface layer into any suitable digital touch input data. Suitable digital touch input data for at least one embodiment may include, for example, touch location or coordinate data.

Touch control logic 824 may be coupled to help control touch sensor interface circuitry 822 in any suitable manner to detect touch input over a first touch surface layer and a second touch surface layer. Touch control logic 824 for at least one example embodiment may also be coupled to output in any suitable manner digital touch input data corresponding to touch input detected by touch sensor interface circuitry 822. Touch control logic 824 may be implemented using any suitable logic, including any suitable hardware, firmware, and/or software logic (e.g., non-transitory tangible media), that may depend, for example, at least in part on the circuitry used for touch sensor interface circuitry 822. Touch control logic 824 for at least one embodiment may support any suitable multi-touch technology.

Touch control logic 824 may be coupled to output digital touch input data to system control logic 806 and/or at least one processor 804 for processing. At least one processor 804 for at least one embodiment may execute any suitable software to process digital touch input data output from touch control logic 824. Suitable software may include, for example, any suitable driver software and/or any suitable application software. As illustrated in FIG. 8, system memory 808 may store suitable software 826 and/or non-volatile memory and/or storage device(s).

Note that in some example implementations, the functions outlined herein may be implemented in conjunction with logic (e.g., provisioned in user equipment 12 and/or localization and access point information services module 14, etc.) that is encoded in one or more tangible machine readable storage media (e.g., embedded logic provided in an application-specific integrated circuit (ASIC), in digital signal processor (DSP) instructions, software (potentially inclusive of object code and source code) to be executed by a processor, or other similar machine, etc.), which may be inclusive of non-transitory media. In some of these instances, memory elements can store data used for the operations described herein. This can include the memory elements being able to store software, logic, code, or processor instructions that are executed to carry out the activities described herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), a DSP, an erasable programmable read only memory (EPROM), electrically erasable programmable read-only memory (EEPROM)) or an ASIC that can include digital logic, software, code, electronic instructions, or any suitable combination thereof.

Note that with the examples provided above, as well as numerous other examples provided herein, interaction may be described in terms of layers, protocols, interfaces, spaces, and environments more generally. However, this has been done for purposes of clarity and example only. In certain cases, it may be easier to describe one or more of the functionalities of a given set of flows by only referencing a limited number of components. It should be appreciated that the architectures discussed herein (and its teachings) are readily scalable and can accommodate a large number of components, as well as more complicated/sophisticated arrangements and configurations. Accordingly, the examples provided should not limit the scope or inhibit the broad teachings of the present disclosure, as potentially applied to a myriad of other architectures.

It is also important to note that the blocks in the flow diagrams illustrate only some of the possible signaling scenarios and patterns that may be executed by, or within, the circuits discussed herein. Some of these blocks may be deleted or removed where appropriate, or these operations or activities may be modified or changed considerably without departing from the scope of teachings provided herein. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by the present disclosure in that any suitable arrangements, chronologies, configurations, and timing mechanisms may be provided without departing from the teachings provided herein.

It is also imperative to note that all of the Specifications, protocols, and relationships outlined herein (e.g., specific commands, timing intervals, supporting ancillary components, etc.) have only been offered for purposes of example and teaching only. Each of these data may be varied considerably without departing from the spirit of the present disclosure, or the scope of the appended claims. The specifications apply to many varying and non-limiting examples and, accordingly, they should be construed as such. In the foregoing description, example embodiments have been described. Various modifications and changes may be made to such embodiments without departing from the scope of the appended claims. The description and drawings are, accordingly, to be regarded in an illustrative rather than a restrictive sense.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

### OTHER NOTES AND EXAMPLES

Example A1 is an apparatus for managing connection costs and bandwidth on mobile devices, comprising: logic at least a portion of which is in hardware, the logic to: determine a location of a mobile device along a route from a first location to a second location, where a plurality of wireless networks are available along the route and automatically switch from a first connection between the mobile device and a first wireless network to a second connection between the mobile device and a second wireless network.

In Example A2, the subject matter of Example A1 can optionally include further logic to set one or more policies, where the policies are used by a network decision module to determine when to switch from the first connection to the second connection.

In Example A3, the subject matter of Example A2 can optionally include where one of the policies is a quality of service.

In Example A4, the subject matter of any one of the Examples A2-A3 can optionally include where one of the policies is a cost of service.

In Example A5, the subject matter of Example A1 can optionally include further logic to monitor the signal strength of the first connection to the first wireless network and send a signal to switch to the second connection when the signal strength of the first connection to the first network falls below a threshold.

In Example A6, the subject matter of any one of the Examples A1-A5 can optionally include where the location of the apparatus is determined by a global positioning system.

In Example A7, the subject matter of any one of the Examples A1-A6 can optionally include where a route planner can display the plurality of wireless networks available along the route.

In Example A8, the subject matter of Example A7 can optionally include further logic to allow for selection of at least one of the displayed plurality of wireless networks to be connected to while on the route.

In Example A9, the subject matter of any one of Examples A1-A8 can optionally include further logic to read a configuration file to determine, based on the location of the apparatus, a next network connection to be established, where the next network connection is different than the first network connection.

In Example A10, the subject matter of any one of Examples A1-A9 can optionally include further logic to analyze a previously taken route to determine when to automatically switch from the first connection to the second connection.

In Example A11 the subject matter of any one of Examples A1-A10 can optionally include where a list of available networks along a route is obtained using localization and access point information services module.

In Example A12, the subject matter of any one of Examples A1-A11 can optionally include where the first wireless network is a LTE cell, a WiMax cell, a 3G cell, or a 4G cell.

In Example A13 the subject matter of any one of Examples A1-A12 can optionally include where the mobile device is a cellular telephone.

Example M1 is a method for mitigating unauthorized access to data traffic, comprising: determining a location of a mobile device along a route from a first location to a second location, where a plurality of wireless networks are available along the route and automatically switching from a first connection between the mobile device and a first wireless network to a second connection between the mobile device and a second wireless network.

In Example M2, the subject matter Example M1 can optionally include setting one or more policies, where the policies are used by a network decision module to determine when to switch from the first connection to the second connection.

In Example M3, the subject matter of Example M2 can optionally include where one of the policies is a quality of service.

In Example M4, the subject matter of any one of Examples M2-M3 can optionally include where one of the policies is a cost of service.

In Example M5, the subject matter of Example M1 can optionally include monitoring the signal strength of the first connection to the first wireless network and sending a signal to switch to the second connection when the signal strength of the first connection to the first network falls below a threshold.

In Example M6, the subject matter of any one of the Examples M1-M5 can optionally include where the location of the apparatus is determined by a global positioning system.

In Example M7, the subject matter of any one of Examples M1-M6 can optionally include where a route planner can display the plurality of wireless networks available along the route.

In Example M8, the subject matter of Example M7 can optionally include allowing for selection of at least one of the displayed plurality of wireless networks to be connected to while on the route.

In Example M9, the subject matter of any one of Examples M1-M8 can optionally include reading a configuration file to determine, based on the location of the apparatus, a next network connection to be established, where the next network connection is different than the first network connection.

In Example M10, the subject matter of any one of the Examples M1-M9 can optionally include analyzing a previously taken route to determine when to automatically switch from the first connection to the second connection.

In Example M11, the subject matter of any one of Examples M1-M10 can optionally include where a list of available networks along a route is obtained using a localization and access point information services module.

In Example M12, the subject matter of any one of Examples M1-M11 can optionally include where the first wireless network is a LTE cell, a WiMax cell, a 3G cell, or a 4G cell.

In Example M13, the subject matter of any one of Examples M1-M12 can optionally include where the mobile device is a cellular telephone.

In Example M14, the subject matter of any one of Examples M1-M13 can be executed by at least one machine-readable storage medium.

Example E1 is an apparatus for managing connection costs and bandwidth on mobile devices, comprising means for: determining a location of a mobile device along a route from a first location to a second location, where a plurality of wireless networks are available along the route and automatically switching from a first connection between the mobile device and a first wireless network to a second connection between the mobile device and a second wireless network.

In Example E2, the subject matter of Example E1 can optionally include further means for setting one or more policies, where the policies are used by a network decision module to determine when to switch from the first connection to the second connection.

In Example E3, the subject matter of any one of the Examples E2 can optionally include where one of the policies is a cost of service.

Example X1 is a machine-readable storage medium including machine-readable instructions, when executed, to implement a method or realize an apparatus as in any one of the Examples A1-A13 and M1-M13.

Example Y1 is an apparatus comprising means for performing of any of the Example methods M1-M13.

In Example Y2, the subject matter of Example Y1 can optionally include the means for performing the method comprising a processor and a memory.

In Example Y3, the subject matter of Example Y2 can optionally include the memory comprising machine-readable instructions, that when executed cause the apparatus to perform any of the Example methods M1-M13.

In Example Y4, the subject matter of any one of Examples Y1-Y3 can optionally include the apparatus being a mobile device or a computing system.

What is claimed is:

1. An apparatus for managing connection costs and bandwidth on mobile devices, comprising:
logic, at least a portion of which is in hardware, the logic to:
determine a location of a mobile device along a route from a first location to a second location, wherein a plurality of wireless networks are available along the route; and
switch from a first connection between the mobile device and a first wireless network to a second connection between the mobile device and a second wireless network.

2. The apparatus of claim 1, the apparatus further comprising logic to:
set one or more policies, wherein the policies are used by a network decision module to determine when to switch from the first connection to the second connection.

3. The apparatus of claim 2, wherein one of the policies is a quality of service.

4. The apparatus of claim 2, wherein one of the policies is a cost of service.

5. The apparatus of claim 1, the apparatus further comprises logic to:
monitor the signal strength of the first connection to the first wireless network; and
send a signal to switch to the second connection when the signal strength of the first connection to the first network falls below a threshold.

6. The apparatus of claim 1, wherein the location of the apparatus is determined by a global positioning system.

7. The apparatus of claim 1, wherein a route planner can display the plurality of wireless networks available along the route.

8. The apparatus of claim 7, the apparatus further comprising logic to:
allow for selection of at least one of the displayed plurality of wireless networks to be connected to while on the route.

9. The apparatus of claim 1, the apparatus further comprising logic to:
read a configuration file to determine, based on the location of the apparatus, a next network connection to be established, wherein the next network connection is different than the first network connection.

10. The apparatus of claim 1, the apparatus further comprises logic to:
analyze a previously taken route to determine when to automatically switch from the first connection to the second connection.

11. The apparatus of claim 1, wherein a list of available networks along a route is obtained using a localization and access point information services module.

12. The apparatus of claim 1, wherein the first wireless network is a LTE cell, a WiMax cell, a 3G cell, or a 4G cell.

13. The apparatus of claim 1, wherein the mobile device is a cellular telephone.

14. At least one machine readable non-transitory storage medium comprising instructions that, when executed, cause an apparatus to:
determine a location of a mobile device along a route from a first location to a second location, wherein a plurality of wireless networks are available along the route; and
switch from a first connection between the mobile device and a first wireless network to a second connection between the mobile device and a second wireless network.

15. The medium of claim 14, further comprising instructions to:
set one or more policies, wherein the policies are used by a network decision module to determine when to switch from the first connection to the second connection.

16. The medium of claim 15, wherein one of the policies is a quality of service.

17. The medium of claim 15, wherein one of the policies is a cost of service.

18. The medium of claim 14, further comprising instructions to:
monitor the signal strength of the first connection to the first wireless network; and
send a signal to switch to the second connection when the signal strength of the first connection to the first network falls below a threshold.

19. The medium of claim 14, wherein the location of the apparatus is determined by a global positioning system.

20. The medium of claim 14, wherein a route planner can display the plurality of wireless networks available along the route.

21. The medium of claim 20, further comprising instructions to:
allow for selection of at least one of the displayed plurality of wireless networks to be connected to while on the route.

22. The medium of claim 14, further comprising instructions so:
read a configuration file to determine, based on the location of the apparatus, a next network connection to be established, wherein the next network connection is different than the first network connection.

23. The medium of claim 14, further comprising instructions to:
analyze a previously taken route to determine when to automatically switch from the first connection to the second connection.

24. A method for managing connection costs and bandwidth on mobile devices, comprising:
determining, by a mobile device that includes a processor, a location of the mobile device along a route from a first location to a second location, wherein a plurality of wireless networks are available along the route;
switching from a first connection between the mobile device and a first wireless network to a second connection between the mobile device and a second wireless network; and
setting one or more policies, wherein the policies are used by a network decision module to determine when to switch from the first connection to the second connection.

25. The method of claim 24, further comprising:
monitoring the signal strength of the first connection to the first wireless network; and
sending a signal to switch to the second connection when the signal strength of the first connection to the first network falls below a threshold.
